(19) United States
(12) Patent Application Publication
(10) Pub. No.: US 2017/0005402 A1
(43) Pub. Date: Jan. 5, 2017

(54) MULTIBAND COMMUNICATIONS AND REPEATER SYSTEM

(71) Applicant: GOVERMENT OF THE UNITED STATES AS REPRESENTED BY TE SECRETARY OF THE AIR FORCE, ROME, NY (US)

(72) Inventor: Daniel W. Stambovsky, Columbia, MD (US)

(21) Appl. No.: 15/264,643

(22) Filed: Sep. 14, 2016

Related U.S. Application Data
(62) Division of application No. 14/703,959, filed on May 5, 2015.

(51) Int. Cl. H01Q 1/28; H01Q 5/30; H01Q 9/04; H01Q 1/36

(52) U.S. Cl. CPC H01Q 1/286; H01Q 1/36; H01Q 5/30; H01Q 9/0407; H04B 7/18504

(57) ABSTRACT

Apparatus for multi-band simultaneous high and low frequency communications utilizing a variable geometry type antenna. Apparatus operates simultaneously in a broadcast mode on low frequencies and in a directed mode on high frequencies. Radiating elements are individually selectable in the directed mode to permit phasing and resultant beam steering. The geometry, arrangement and number of radiating elements are chosen such that radio frequency coupling amongst the radiating elements will occur at the broadcast mode frequency so as to cause the radiating elements, collectively, and therefore the antenna to structure, to resonate in broadcast mode thereby producing a e omnidirectional radiating pattern.

### REFERENCE TO PRIOR APPLICATIONS UNDER 35 U.S.C. §120

This patent application is a Continuation-in-Part of and claims the priority to benefit of pending non-provisional application Ser. No. 14/703,959, having been filed in the United States Patent and Trademark Office on May 5, 2015 and now incorporated by reference herein.

### STATEMENT OF GOVERNMENT INTEREST

The invention described herein may be manufactured and used by or for the Government for governmental purposes without the payment of any royalty thereon.

### BACKGROUND OF THE INVENTION

This invention relates to the use of a software definable pixelated patch antenna as the is front end of a low to high frequency and high to low frequency translator for communications systems.

There is a continuous and ongoing effort to bridge the gap between low frequency omni-directional communications systems with high-frequency Low Probability of Intercept (LPI) systems. Current translation efforts involve multiple antenna systems and are cumbersome and cannot be installed on the platforms which could gain the most use thereof.

It is clearly desirable to have a system capable of operating simultaneously on both the low and high frequency bandwidths while maintaining a small overall footprint, however until recently the antenna portion of such a system was lacking, U.S. Pat. No. 8,654,034B2 to Legare for example discloses various antenna systems simultaneously capable of functioning independently on a low and high frequency. This prior art, however, is focused on the functioning of the reconfigurable portions of the antennas themselves and not their application.

### OBJECTS AND SUMMARY OF THE INVENTION

It is therefore an object of the present invention to provide an apparatus that overcomes the prior art's dependency on separate fixed, non-reconfigurable antennas, each with their independent radio system for high and low frequency applications.

It is a further object of the present invention to provide an apparatus with the capability of automatically repeating and transmitting received communications on one band into the other (i.e. receiving data o a low frequency link and retransmitting it on a high frequency band).

Briefly stated, the present invention, an onboard aircraft system for air-to-air communications, achieves these and other objects utilizing multi-band simultaneous high and low frequency communications in a variable geometry type antenna. The system operates simultaneously in a broadcast mode on low frequencies and in a directed mode on high frequencies. Radiating elements are individually selectable in the directed mode to permit phasing and resultant beam steering. The geometry, arrangement and number of radiating elements are chosen such that radio frequency coupling amongst the radiating elements will occur at the broadcast mode frequency so as to cause the radiating elements, collectively, and therefore the antenna structure, to resonate in broadcast mode thereby producing a near omnidirectional radiating pattern.

The above, and other objects, features and advantages of the present invention will become apparent from the following description read in conjunction with the accompanying drawings, in which like reference numerals designate the same elements.

The present invention overcomes the shortcomings of the prior art by envisaging a unique means of using the antenna systems as well as different transmit and receive equipment not provided in the prior art. The present invention utilizes a conformal pixelated patch-shaped or display type antenna whose overall geometry has a resonant frequency at the lower frequency band (for example about 960 MHz for a square 115×115 mm) and a pixel element capable of beam steering above 5 GHz. This allows dual band use of the same antenna with the low frequency band using the entire patch (i.e., all radiating elements) in a standard manner while the high frequency band is taking advantage of the reconfigurable nature (i.e., selectable radiating elements) of these antenna types.

### BRIEF DESCRIPTION OF THE DRAWINGS

FIG. 1 is a schematic diagram representation of a preferred embodiment of the present invention.

FIG. 2 depicts a use of the present invention for the purposes of airborne communications.

FIG. 3 is a schematic diagram depicting the various RF feeds off a pixelated patch antenna.

### DETAILED DESCRIPTION OF THE PREFERRED EMBODIMENT

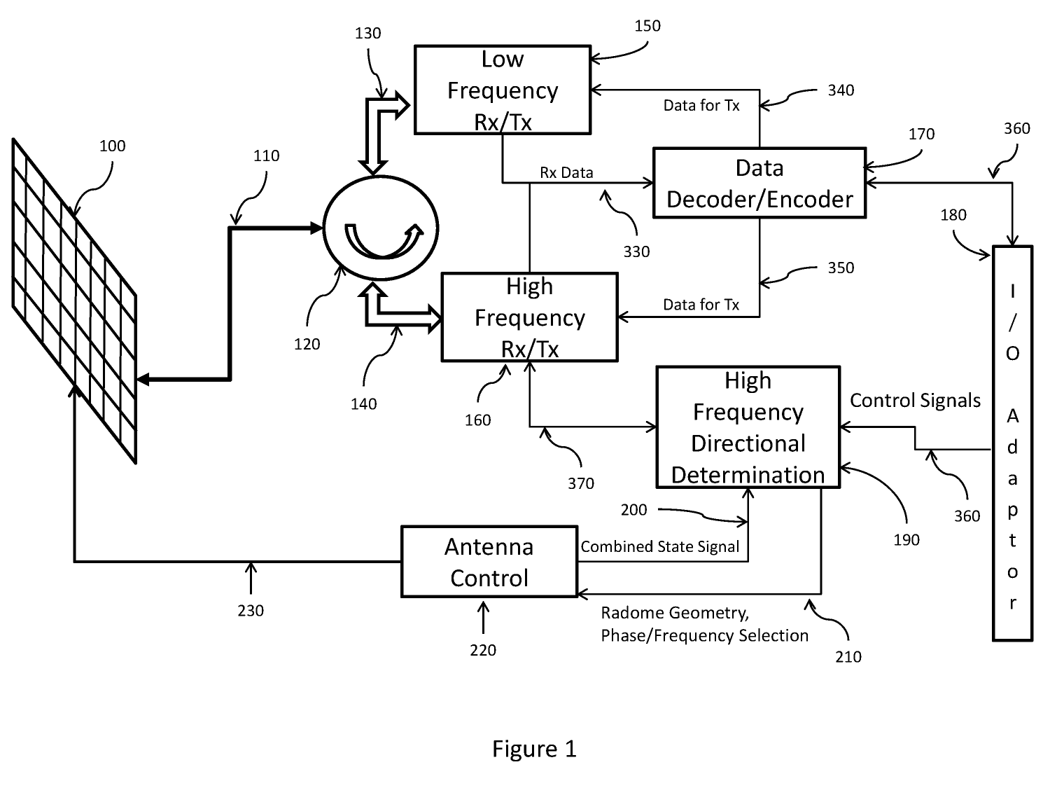

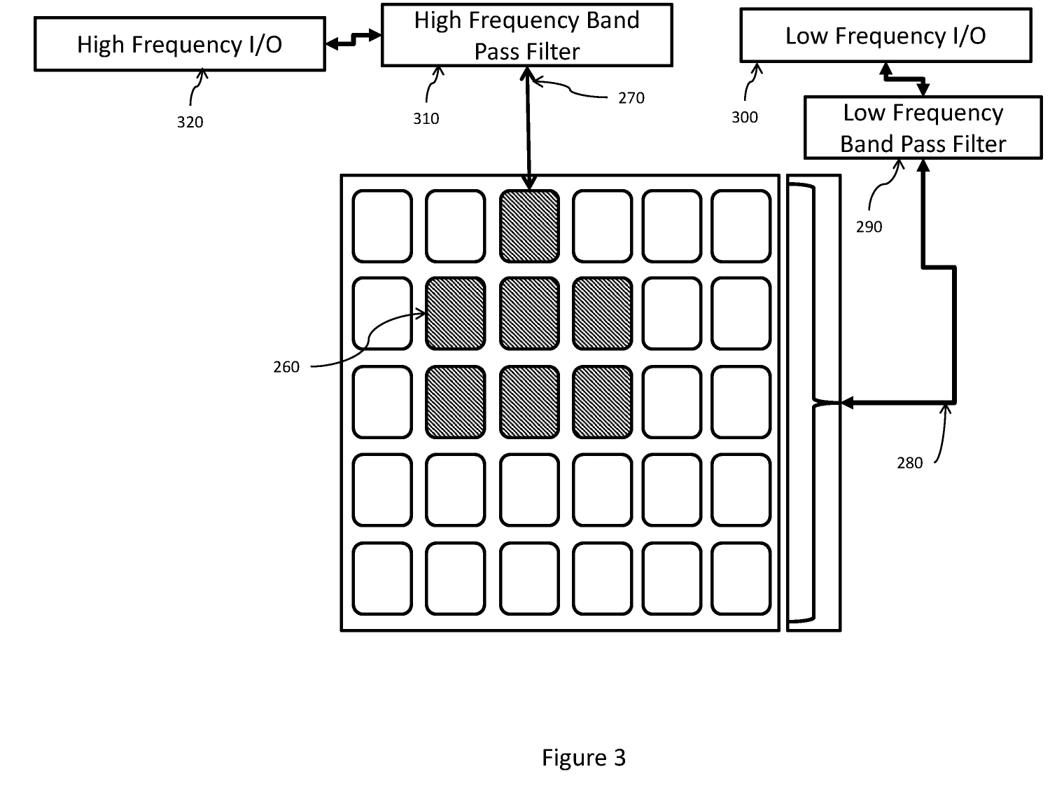

Referring to FIG. 1, the present invention, called a Multiband Communications and Repeater System (MCaRS), is composed of a reconfigurable pixelated patch or display type antenna 100 with simultaneous radio frequency (RF) transmit (Tx) and receive (Rx) signals (i.e., modes) 110 coming from both low and high frequency systems. There are multiple possible means of separating the high and low frequency RF, the means envisioned here consists of a circulator 120 with ports designed to admit only the proper low and high frequency RF 130 and 140 to the respective Rx/Tx communications systems 150 and 160, although alternate installations could rely on hand pass filters for this purpose as seen in FIG. 3 290 and 310. The received data 330 is sent to the Data Decoder/Encoder 170 which, based on requirements, determines if the data needs to be resent via the high or low frequency Rx/Tx and properly formats the data for the appropriate system 340 and 350 thus acting as a repeater. For pre-existing commercial or government radio systems (which would replace the Rx/Tx systems 150 and 160) the Decoder/Encoder 170 would ensure the data is properly formatted for each radio system, while also sending the data 360 to and from the I/O Adaptor 180 as necessary. The High Frequency Directional Determination system 190 accepts control signals 380 from the I/O Adaptor 180 and the separate signals 370 from the High Frequency Rx/Tx 160 to control the display antenna via the Antenna Control 220, ensuring the proper beam shaping for the high frequency capability.

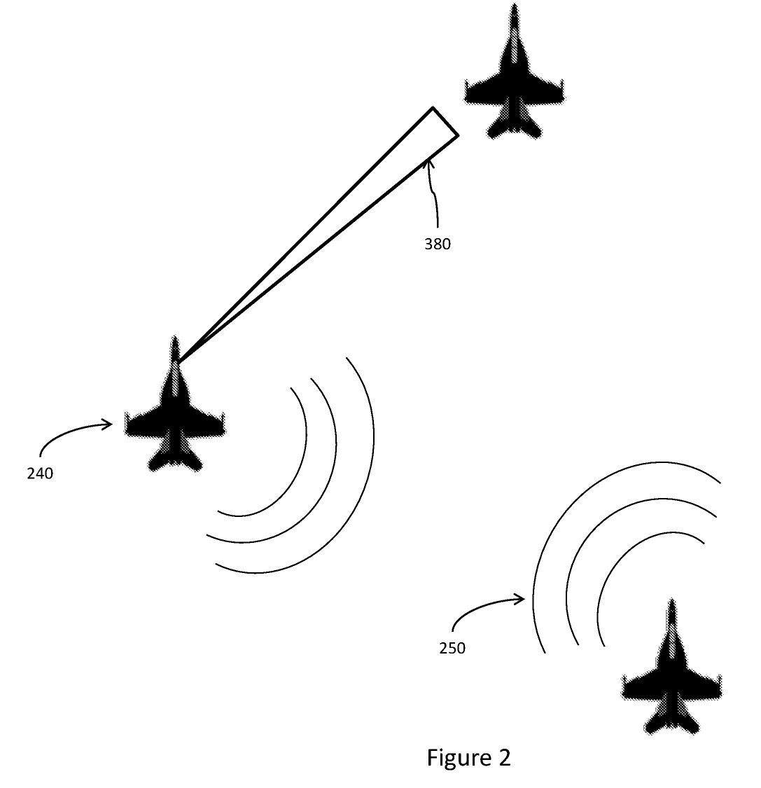

FIG. 2 shows an application of the present invention as an airborne communications system. An aircraft 240 is depicted communication with two other aircraft using both low frequency modes 250 denoted by non-directionality of the radiating patterns and high frequency modes 380 denoted by highly directive radiation patterns.

FIG. 3 shows how the high frequency RF 270 is fed to the adaptive portion of the antenna 260, here shown as a pixelated patch (i.e., selectable radiating element). The entire antenna (i.e., all antenna radiating elements), meanwhile, serves to provide the antenna for the low frequency RF 280 due to inter-element coupling at low frequencies when the number of radiating elements and their dimensions and arrangement is appropriately chosen to collectively resonate at the desired low frequency RF frequency. In the instantiation shown in FIG. 3 the high and low frequency RF are fed (i.e. routed to and from) off separate feeds to and pass through the appropriate band pass fitter 290 and 310 (as an alternate embodiment to the use of a circulator 120) before being sent to the various Tx/Rx modules via high and low frequency I/O elements 300 and 320.

### DETAILED DESCRIPTION OF AN ALTERNATE EMBODIMENT

An alternate embodiment would be mostly identical, however the circulator method of separating frequency bands FIG. 1 120 would be replaced by a set of high and low frequency band pass filters similar to the method shown in FIG. 3.

Having described preferred embodiments of the invention with reference to the accompanying drawings, it is to be understood that the invention is not limited to those precise embodiments, and that various changes and modifications may be effected therein by one skilled in the art without departing from the scope or spirit of the invention as defined in the appended claims.

What is claimed is:

1. An onboard aircraft system for air-to-air communications, comprising:
a means for generating a directional mode beam;
a means for generating a broadcast mode beam; wherein
said means for generating said directional mode beam comprises
a plurality of selectable antenna radiating elements; and
a means for routing a high frequency signal to and from said selected antenna radiating elements; and
said means for generating broadcast mode beam comprises
said plurality of selectable antenna radiating elements having a predetermined quantity and geometric dimension and arrangement so as to provide radio frequency resonant coupling between said entire plurality only at said broadcast beam's frequency; and
a means for routing a low frequency signal to and from said geometrically selected antenna radiating elements
so as to permit
any of said aircraft to direct to and receive from only one of any other said aircraft, said high frequency signals; and
any of said aircraft to simultaneously broadcast to and receive from a plurality of any other said aircraft, said low frequency signals.

2. The system of claim 1, wherein
said means for generating said directional mode beam and said broadcast mode beam further comprises:
a high frequency transmitter/receiver coupled to said means for routing; and
a low frequency transmitter/receiver coupled to said means for routing;
an antenna controller for directing said means for routing; and
a circulator for isolating said high frequency transmitter/receiver from said a low frequency transmitter/receiver.
